(19) United States
(12) Patent Application Publication
(10) Pub. No.: US 2003/0086208 A1
(43) Pub. Date: May 8, 2003

(54) Bi-stable inertial air latch

(76) Inventors: Yiren Hong, Singapore (SG); TakKoon Ooi, Singapore (SG); ChorShan Cheng, Singapore (SG); Choon Kiat Lim, Singapore (SG); Mo Xu, Singapore (SG)

Correspondence Address: Derek J. Berger, Seagate Technology LLC, Intellectual Property- COL2LGL, 389 Disc Drive, Longmont, CO, 80503, US

(21) Appl. No.: 10/185,449

(22) Filed: Jun. 28, 2002

Related U.S. Application Data
(60) Provisional application No. 60/333,026, filed on Nov. 5, 2001.

(51) Int. Cl. G11B 5/54

(52) U.S. Cl. 360/256.1

(57) ABSTRACT

Disclosed is an actuator latch for keeping an actuator in a park position when the drive is subject to non-operating shock. Magnetic forces hold the latch in both its latched and unlatched positions. VCM-controlled actuator movement causes the latch to move both into and out of these positions. Airflow generated by spinning discs effect movement of the latch out of the latching position when the drive is powered up.

### CROSS REFERENCE TO RELATED APPLICATION

This application claims the benefit of U.S. Provisional Application No. 60/333,026, filed Nov. 5, 2001.

### FIELD OF THE INVENTION

This invention relates generally to the field of hard disc drive data storage devices, and more particularly, but not by way of limitation, to disc drive actuators.

### BACKGROUND OF THE INVENTION

Disc drives of the type known as “Winchester” disc drives, or hard disc drives, are well known in the industry. Such disc drives magnetically record digital data on a plurality of circular, concentric data tracks on the surfaces of one or more rigid discs. The discs are typically mounted for rotation on the hub of a brushless DC spindle motor. In disc drives of the current generation, the spindle motor rotates the discs at speeds of up to 15,000 RPM.

Data are recorded to and retrieved from the discs by ate least one read/write head assembly, also known as a head or slider, which are controllably moved from track to track by an actuator assembly. Where more than one head is used, an array of heads are typically vertically aligned. The read/write head assemblies typically comprise an electromagnetic transducer carried on an air bearing slider. This slider acts in a cooperative pneumatic relationship with a thin layer of air dragged along by the spinning discs to fly the head assembly in a closely spaced relationship to the disc surface. In order to maintain the proper flying relationship between the head assemblies and the discs, the head assemblies are attached to and supported by flexures attached to the actuator.

The actuator assembly used to move the heads from track to track has assumed many forms historically, with most disc drives of the current generation incorporating an actuator of the type referred to as a rotary voice coil actuator. A typical rotary voice coil actuator consists of a pivot shaft fixedly attached to the disc drive housing base member closely adjacent the outer diameter of the discs. The pivot shaft is mounted such that its central axis is normal to the plane of rotation of the discs. The actuator is mounted to the pivot shaft by precision ball bearing assemblies within a bearing housing. The actuator supports a flat coil which is suspended in the magnetic field of an array of permanent magnets, which are fixedly mounted to the disc drive housing base member.

On the side of the actuator bearing housing opposite to the coil, the actuator assembly typically includes one or more vertically aligned, radially extending actuator head mounting arms, to which the head suspensions mentioned above are mounted. These actuator arms extend between the discs, where they support the head assemblies at their desired positions adjacent the disc surfaces. When controlled DC current is applied to the coil, a magnetic field is formed surrounding the coil which interacts with the magnetic field of the permanent magnets to rotate the actuator bearing housing, with the attached head suspensions and head assemblies, in accordance with the well-known Lorentz relationship. As the actuator bearing housing rotates, the heads are moved generally radially across the data tracks of the discs along an arcuate path.

When the power to the disc drive is turned off, the disc stops rotating. This means that the slider stops flying and returns to the surface of the disc. Some disc drives have a specified landing zone on the disc surface for the slider to land on. This landing zone is typically near the outer edge or near the center of the disc surface, and it is designed so that the head can contact the landing zone without causing damage to the surface of the disc. This may be accomplished in a number of ways, but one conventional method is to texture the discs to prevent static friction, or “stiction” to develop between the surfaces of the disc and head. Other disc drive have a ramp which allows the actuator to move the head radially away from the disc and then lifted away from the surface of the disc.

Whether the head is “parked” in a landing zone, on a ramp, or some other location, it is desirable that the actuator be held in the parked position when the power to the disc drive is turned off. This is because the voice coil motor no longer controls the actuator, so if the disc drive is subject to a shock, the actuator arm can drift onto the disc. This can cause permanent damage to a disc. Disc drives are typically provided with some sort of “latch” for this purpose. The latch must prevent movement of the actuator out of the parked position when the actuator is not driven by the VCM, but must also allow the actuator to pivot once power is restored to the drive.

Historically, latches have taken a number of different forms. For example, some latches have a stationary magnet fixed to the deck and a ferromagnetic element attached to the actuator, such that the magnet holds the ferromagnetic element and thereby the actuator in place when the actuator is parked. The latching power of such a latch is often difficult to predict, and when too powerful can slow data access and increase power consumption. Others include springs which bias the latch toward a position in which it engages the actuator when it is in the parked position, and is moved out of engagement with the actuator by the use of an electromechanical device such as a solenoid when power is restored to the drive. However, such latches can be complex to manufacture and expensive to install. Still others rely on the mere inertia of a latch body to move it into engagement with the actuator when the drive is subject to shock. This type of latch is prone to rebounding away from the actuator after latching, however, such that it is incapable of responding to a second shock before the actuator has left the park position.

One type of latch which is of particular relevance here is known as an air latch, which is biased toward a latch position but moves out of engagement with a parked actuator in response to airflow generated when power is restored to the drive and the discs begin to spin. A disadvantage of the air latch is that when power is removed from the drive and the discs slow down (called “spindown”), air currents are still capable of keeping the latch out of its latching position. Even when the actuator has been parked, a shock during spindown may unpark the actuator and return a head into contact with a disc surface.

Yet another type of latch of particular relevance is what is known as a “bistable” latch. This type of latch is configured so as to use magnetic forces to hold it in place in both the latched and unlatched positions. VCM-controlled movement of the actuator is responsible for moving the latch into and out of both the latched and unlatched positions. When subject to shock, magnetic force in combination with the inertia of the latch body prevents movement out of the latched position despite the rotational force exerted upon it by the actuator. A difficulty with this type of latch is that while increasing the magnetic force in the latched position prevents unwanted actuator movement, it also increases the amount of VCM current required to move the actuator so as to force the latch out of the latched position when power is restored to the drive. This has the effect of increasing the time for the head to return to the disc and increases power consumption as well. Taken to an extreme, unlatching may be prevented altogether. In any case, it should be clear that the bi-stable latch will always present a trade-off between the forces required to latch the actuator in the face of shock and to unlatch the actuator when power is restored to the drive.

What the prior art has been lacking is a low-cost actuator latch which effectively prevents movement of an actuator out of its parked position while minimizing the amount of power required to release the actuator when power is restored to the drive.

### SUMMARY OF THE INVENTION

The present invention is directed to an actuator latch for keeping an actuator in a park position when the drive is subject to non-operating shock. Magnetic forces hold the latch in both its latched and unlatched positions. VCM-controlled actuator movement causes the latch to move both into and out of these positions. Airflow generated by spinning discs effect movement of the latch out of the latching position when the drive is powered up.

These and other features and benefits will become apparent upon review of the following figures and the accompanying detailed description.

### BRIEF DESCRIPTION OF THE DRAWINGS

FIG. 1 shows a plan view of a disc drive in which a first embodiment of the latch of the present invention is in a latching position, holding an actuator in a parked position.

FIG. 2 shows a plan view of a disc drive in which the latch is moved out of its latching position.

FIG. 3 shows a plan view of a disc drive in which the latch remains out of the latched position as the actuator moves over a surface of a disc.

FIG. 4 shows a plan view of a disc drive in which the actuator is returning to its parked position.

FIG. 5 shows a plan view of a disc drive in which the actuator has returned to its parked position, returning the latch to the latching position.

### DETAILED DESCRIPTION OF THE INVENTION

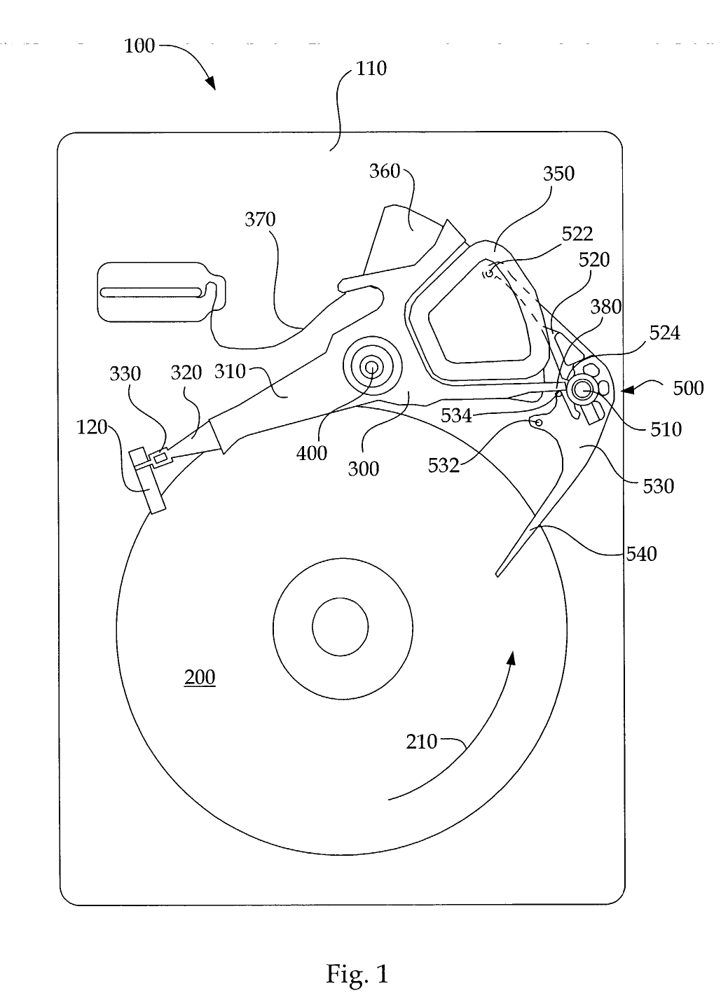

Turning now to the drawings and specifically to FIG. 1, shown is an exploded view of an example of a disc drive 100 in which the present invention is particularly useful. The disc drive 100 includes a deck 110 to which all other components are directly or indirectly mounted and a top cover (not shown) which, together with the deck 110, forms a disc drive housing which encloses delicate internal components and isolates these components from external contaminants.

The disc drive 100 includes at least one disc 200 which is mounted for rotation on a spindle motor (not shown). The disc or discs 200 include on their surfaces a plurality of circular, concentric data tracks on which data are recorded one or more vertically aligned head assemblies 330. The head assemblies 330 are supported by flexures 320, which are attached to arms 310 of actuator 300. The actuator 300 is mounted to a bearing assembly 400 about which the actuator 300 rotates.

Power to drive the actuator 300 about the pivot assembly 400 is provided by a voice coil motor (VCM). The VCM includes a coil 350 which is supported by the actuator 300 within the magnetic field of a permanent magnet assembly having spaced upper and lower magnets, the lower of which is illustrated at 360. Electronic circuitry is provided on a printed circuit board (PCB, not shown) mounted to the underside of the deck 110. Control signals to drive the VCM are carried between the PCB and the moving actuator 300 via a flexible printed circuit cable (PCC) 370, which also transmits data signals to and from the heads 330.

When the drive 100 is to be shut down or power is cut to the drive 100 for some other reason, the actuator 300 is returned to its parked position. In the drive 100 illustrated in FIG. 1, the parked position is one in which the head 330 located on a ramp 120, beyond the outer diameter of disc 200. Ramp 120 is a sloped surface protruding over the edge of disc 200, such that the head 330 is lifted away from the disc 200 and beyond its outer diameter along the surface of ramp 120 as the actuator pivots clockwise. The actuator 300 may be returned to the parked position by any of a number of known methods. For example, it could be driven to this position by the VCM as part of a power down procedure or returned using back EMF generated by discs 200 during spindown where power is cut to the drive.

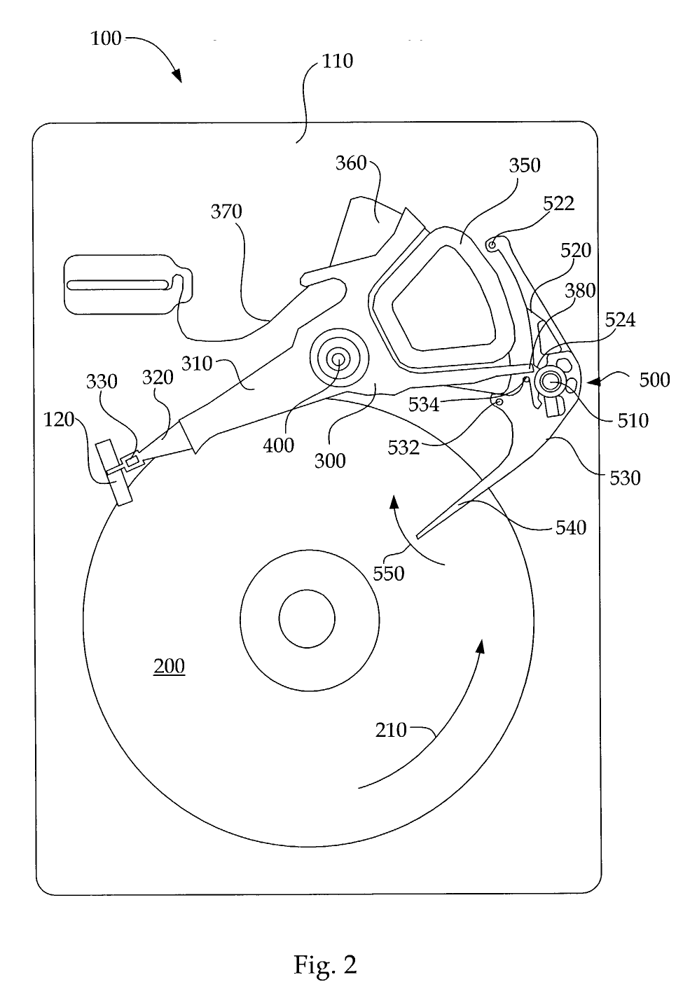

Also shown in FIG. 1 is one embodiment of a latch 500. Latch 500 is pivotally attached to the deck 110 by pivot portion 510. The latch 500 further includes two portions 520,530 extending away from the pivot 510. Each portion 520,530 includes a corresponding ferromagnetic element 522,532 mounted to it. The elements 522,532 may be fixed to the latch 500 by any of a number of methods; for example, they may be injection molded into the latch 500 or fixed to it by adhesives or some other mechanical fasteners. Latch 500 is able to pivot through a range of motion. At one end of this range of motion, when the latch 500 has rotated fully counterclockwise and is latching the actuator 300 in its parked position, element 522 is located within the magnetic field generated by at least one of the magnets of the VCM. The attraction between the magnetic field and element 522 biases the latch 500 into the latching position. Portion 520 also includes a first engagement element, shown in FIG. 2 to take the form of a surface 524 engaging a projection 360 on the actuator 300. While the latch 500 is in the latching position, surface 524 prevents movement of projection 380 when the drive is subject to shock, and thereby latches the actuator 300 in its parked position.

When power is restored to the drive 100, the VCM attempts to drive the actuator 300 in a counterclockwise direction, and projection 380 exerts a force against the surface 524 on portion 520 in an effort to pivot the latch 500 clockwise about pivot 510. This movement is resisted by the attraction between magnetic element 522 and the magnetic field generated by the VCM as explained above, however, and it is for this reason that latch 500 is also provided with a mechanism for facilitating unlatching of the actuator 300. The operation of this mechanism will now be described.

Latch 500 also includes an element which is responsive to airflow generated by disc 200 when it is spinning. Operation is illustrated in FIG. 2, where the airflow-responsive element takes the form of an air vane 540. When power is restored to the drive 100, disc 200 begins spinning in a counterclockwise direction as depicted by arrow 210. Air located above the surface of disc 200 begins moving along with it, and this moving air applies a force to air vane 540. As projection 380 pushes against surface 524, air pushes against air vane 540, and the combined forces are sufficient to rotate the latch 500 in a clockwise direction as illustrated by arrow 550, until surface 524 moves to an extent that projection 380 can move past it. Actuator 300 is now free to move in a counterclockwise direction, such that head 330 may descend ramp 120 and then pass over the surface of the disc to conduct read/write operations.

FIG. 2 depicts the unlatching process just as projection 380 has cleared surface 524 and latch 500 has pivoted clockwise to its full extent. It can also be seen that in this position, while magnetic element 522 has left the magnetic field generated by the VCM, magnetic element 532 has entered the magnetic field. It should be clear that latch 500 is now locked into an unlatched position, where the actuator 300 is free to move without contacting latch 500.

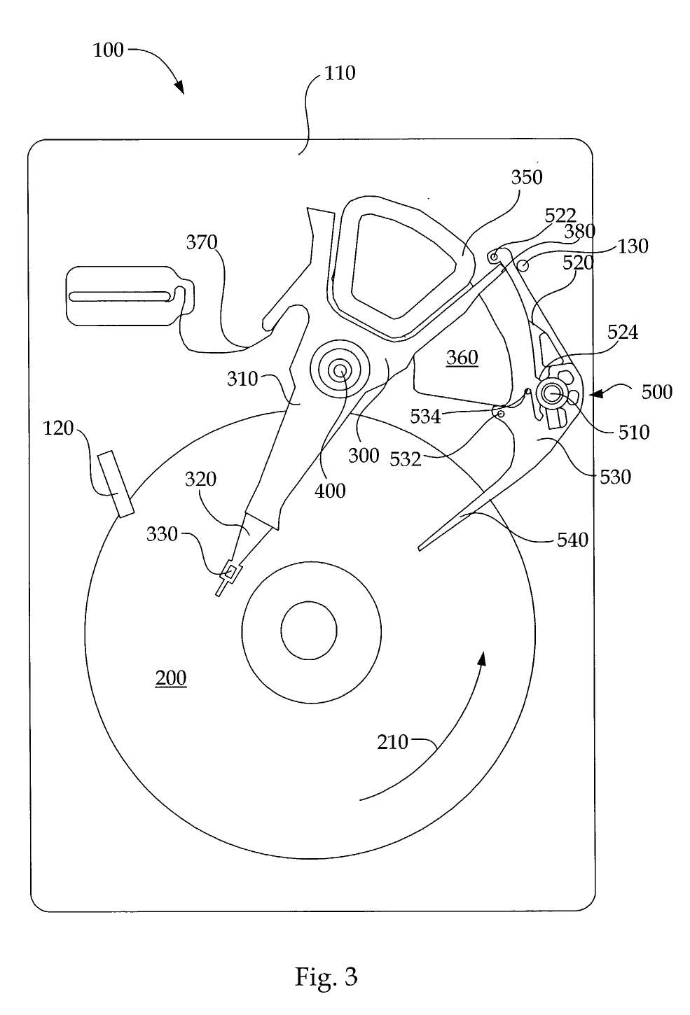

FIG. 3 depicts a disc drive 100 in which the actuator 300 is in a position to allow head 330 to read or write data on disc 200. Note that ferromagnetic element 532 remains in a position in which it is attracted to the magnetic field generated by the voice coil magnets 360. Latch portion 520 may also be provided with a curved surface as illustrated in FIG. 3, allowing full travel of actuator projection 380. Note also that ferromagnetic projection 532 is located in a projection of portion 530 which contacts magnet 360, preventing further clockwise movement of latch 500. A stop pin such as pin 130 illustrated in FIG. 3 may also be used.

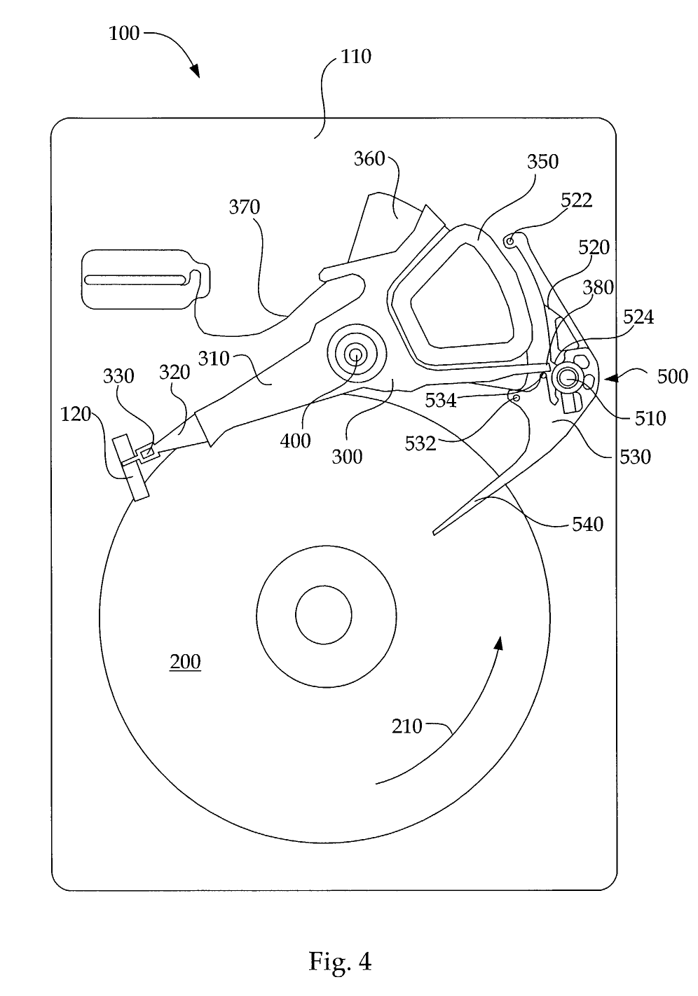

FIG. 4 depicts disc drive 100 in which actuator 300 has moved toward the parked position, just prior to latching of the actuator 300. Note that head 330 has begun to ascend ramp 120, at which point the rotation of disc 200 begins to slow down, as it is no longer necessary to fly the head 330 above disc 200. Projection 380 has just come into contact with surface 534 of latch portion 530.

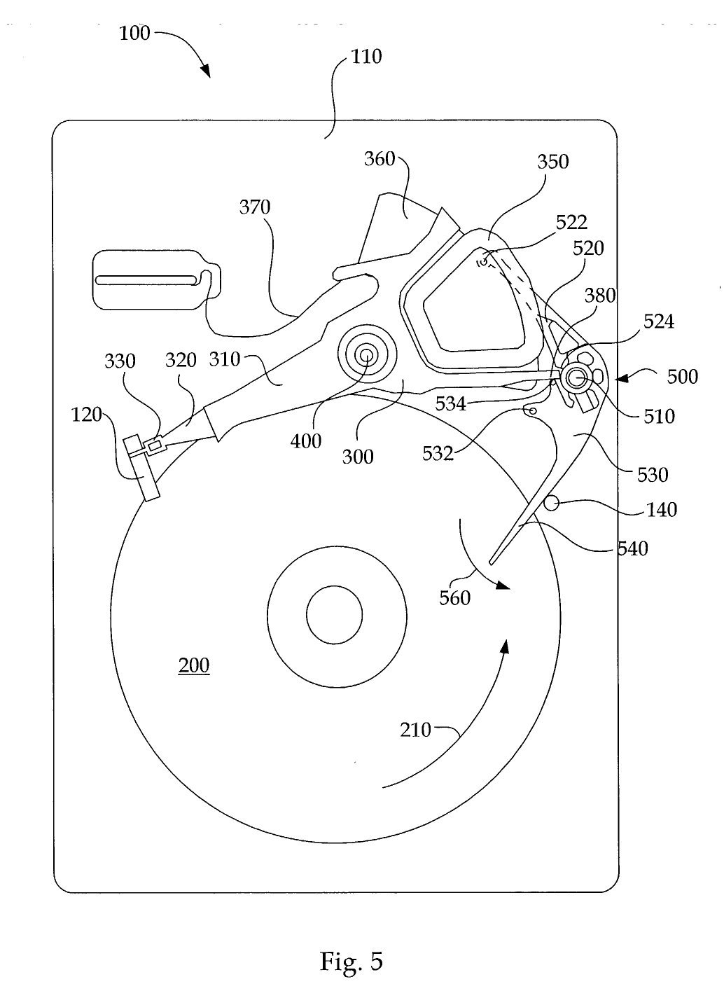

FIG. 5 depicts disc drive 100 in which actuator 300 has reached the parked position, head 330 having fully ascended the ramp. As the actuator 300 is driven clockwise, projection 380 exerts a force on surface 534 of portion 530. This causes the latch 500 to rotate in a counterclockwise direction about pivot 510 as illustrated by arrow 560. This causes ferromagnetic element 522 to enter the magnetic field generated by voice coil magnets 360 once again. Surface 524 is rotated into a position to obstruct movement of actuator projection 380 in a counterclockwise direction. While disc 200 continues to spin down, airflow alone is not sufficient to overcome the bias force provided by ferromagnetic element 522. Only when power is restored to the drive 100, as depicted in FIG. 2, will the combined forces of rotating actuator projection 380 and airflow be sufficient to unlatch the actuator 300. Counter clockwise travel is limited by contact between a projection on portion 520 in which ferromagnetic element 522 is located, though a stop pin such illustrated pin 140 could also be provided.

It should be apparent that the bi-stable inertial air latch 500 described above is particularly effective for preventing an actuator 300 from leaving the parked position during nonoperative shock, while also easily releasing the actuator 300 when power is restored to the drive 100. However, it should also be understood that the latch and/or drive may take other forms without departing from the spirit of the claimed invention. For example, an air vane may be provided to assist a variety of other types of bi-stable inertia latches. One such latch carries a small magnetic element which pivots between two stationary ferromagnetic stop pins, and an air vane would be similarly useful in assisting to unlatch this type of latch. An air vane could also be added to a bi-stable latch which uses an over-center spring arrangement to assist in unlatching of an actuator. Moreover, the air vane 540 depicted in the accompanying drawings is merely illustrative, and could take a variety of other forms so long as it assists in rotation of a bi-stable latch out of a latching position. While the illustrated drive is shown to include a ramp 120, the disclosed latch would be equally useful in a drive in which the parking zone is located on the surface of an outer diameter of disc 200. It is also contemplated that a similar latch could be used in a drive in which a head 330 is parked at an inner diameter of a disc 200, though of course this would require that the latch be position at the other end of magnet 360 and reversed so air vane 540 extends down the left side of a magnet 360 such as that in the accompanying figures. Furthermore, while the term “air” is used throughout this document, it should be understood that this term includes any type of gas and should not be limited to breathable air.

In short, it is apparent that the present invention is particularly suited to provide the benefits described above. While particular embodiments of the invention have been described herein, modifications to the embodiments which fall within the envisioned scope of the invention may suggest themselves to one of skill in the art who reads this disclosure.

Alternatively stated, a first contemplated embodiment of the invention takes the form of a latch for holding a rotatable element (such as 300) in a stationary position. The latch includes a latch body (such as 500), a first element (such as 522) configured to bias the latch body (such as 500) into a first position, a second element (such as 532) configured to bias the latch body (such as 500) into a second position, and a third element (such as 540) configured to urge the latch body (such as 500) out of the first position in response to air movement. The latch body (such as 500) may be rotatable between the first and second positions. Optionally, the first element (such as 522) may be ferromagnetic. The second element (such as 532) may be ferromagnetic. The third element (such as 540) may take the form of a protrusion. The latch may also include a pivot (such as 510) about which the latch body (such as 500) is rotatable where the latch body (such as 500) includes a first portion (such as 520) extending away from the pivot (such as 510) in a first direction and a second portion (such as 530) extending away from the pivot (such as 510) in a second direction, the first element (such as 522) being mounted to the first portion (such as 520) and the second element (such as 532) being mounted to the second portion (such as 530). The third element (such as 540) may be mounted to the second portion (such as 530). The latch may be configured to allow the rotatable element (such as 300) to move out of the stationary position when the latch body (such as 500) is in the second position.

Alternatively stated, a second contemplated embodiment of the invention takes the form of a disc drive (such as 100), including a base (such as 110), at least one disc (such as 200) rotatably mounted to the base (such as 110), an actuator (such as 300) mounted to the base (such as 110) and being rotatable into a parked position, and a latch for holding the actuator (such as 300) in the parked position. The latch includes a latch body (such as 500) which is biased toward a first position when near the first position and is biased toward a second position when near the second position. The latch body (such as 500) is also configured to be urged away from the first position in response to air movement generated by rotation of the disc (such as 200). Rotation of the actuator (such as 300) out of the parked position may urge the latch body (such as 500) out of the first position. A protrusion (such as 380) may be mounted to the actuator (such as 300) and may be configured to contact the latch body (such as 500) when the actuator (such as 300) is in the parked position. The latch body (such as 500) may have a first surface (such as 524), such that the protrusion (such as 380) is configured to exert a force against the first surface (such as 524) so as to urge the latch body (such as 500) away from the first position when the actuator (such as 300) leaves the parked position. The latch body may include a second surface (such as 534), such that the protrusion (such as 380) is configured to exert a force against the second surface (such as 534) so as to urge the latch body (such as 500) toward the first position when the actuator (such as 300) approaches the parked position. The disc drive (such as 100) may further include a magnet (such as 360) for effecting movement of the actuator (such as 300), in which case the latch body (such as 500) includes a first ferromagnetic element (such as 522) for biasing the latch body (such as 500) toward the first position. The latch body may also include a second ferromagnetic element (such as 532) for biasing the latch body (such as 500) toward the second position. The latch body (such as 500) may include an air vane (such as 540) overlying a surface of the disc (such as 200) for urging the latch body (such as 500) away from the first position in response to air movement generated by rotation of the disc (such as 200). Movement of the actuator (such as 300) away from the parked position may urge the latch body (such as 500) away from the first position.

What is claimed is:

1. A latch for holding a rotatable element in a stationary position, the latch comprising:
a latch body;
a first element configured to bias the latch body into a first position;
a second element configured to bias the latch body into a second position; and
a third element configured to urge the latch body out of the first position in response to air movement.

2. The latch of claim 1, in which the latch body is rotatable between the first and second positions.

3. The latch of claim 1, in which the first element is ferromagnetic.

4. The latch of claim 1, in which the second element is ferromagnetic.

5. The latch of claim 1, in which the third element comprises a protrusion.

6. The latch of claim 1, in which the latch further comprises a pivot about which the latch body is rotatable, the latch body further comprising:
a first portion extending away from the pivot in a first direction; and
a second portion extending away from the pivot in a second direction, the first element being mounted to the first portion and the second element being mounted to the second portion.

7. The latch of claim 6, in which the third element is mounted to the second portion.

8. The latch of claim 1, in which the latch is configured to allow the rotatable element to move out of the stationary position when the latch body is in the second position.

9. A disc drive, comprising:
a base;
at least one disc rotatably mounted to the base;
an actuator mounted to the base and being rotatable into a parked position; and
a latch for holding the actuator in the parked position, the latch comprising:
a latch body, the latch body being biased toward a first position when near the first position and being biased toward a second position when near the second position, the latch body further being configured to be urged away from the first position in response to air movement generated by rotation of the disc.

10. The disc drive of claim 9, in which rotation of the actuator out of the parked position urges the latch body out of the first position.

11. The disc drive of claim 9, further comprising:
a protrusion mounted to the actuator, the protrusion being configured to contact the latch body when the actuator is in the parked position.

12. The disc drive of claim 11, in which the latch body further comprises a first surface, the protrusion being configured to exert a force against the first surface so as to urge the latch body away from the first position when the actuator leaves the parked position.

13. The disc drive of claim 11, in which the latch body comprises a second surface, the protrusion being configured to exert a force against the second surface so as to urge the latch body toward the first position when the actuator approaches the parked position.

14. The disc drive of claim 9, further comprising a magnet for effecting movement of the actuator, the latch body further comprising:
a first ferromagnetic element for biasing the latch body toward the first position.

15. The disc drive of claim 14, the latch body further comprising:
a second ferromagnetic element for biasing the latch body toward the second position.

16. The disc drive of claim 9, the latch body comprising:
an air vane overlying a surface of the disc for urging the latch body away from the first position in response to air movement generated by rotation of the disc.

17. The disc drive of claim 16, in which movement of the actuator away from the parked position urges the latch body away from the first position.

18. A disc drive comprising:
at least one rotatable disc;
an actuator movable to a parked position; and
means for latching the actuator in the parked position.

19. The disc drive of claim 18, the latching means further comprising:
an air vane responsive to air movement generated by rotation of the disc.

20. The disc drive of claim 18, further comprising a magnet for effecting movement of the actuator, the latching means further comprising:
a first ferromagnetic element configured to prevent actuator movement when the first ferromagnetic element is near the magnet; and
a second ferromagnetic element configured to allow actuator movement when the second ferromagnetic element is near the magnet.
